(19) United States
(12) Patent Application Publication
(10) Pub. No.: US 2009/0114406 A1
(43) Pub. Date: May 7, 2009

(54) HARROW FRAME AND HARROW FORMED THEREWITH

(75) Inventor: Brian J. Read, Sherwood Park (CA)

Correspondence Address: BENNETT JONES LLP;C/O MS ROSEANN CALDWELL, 4500 BANKERS HALL EAST, 855 - 2ND STREET, SW, CALGARY, AB, T2P 4K7, CA

(73) Assignee: PHOENIX ROTARY EQUIPMENT LTD., Nisku, AB (CA)

(21) Appl. No.: 10/599,981

(22) PCT Filed: Apr. 14, 2005
(86) PCT No.: PCT/CA2005/000581

§ 371 Date: Dec. 29, 2008

Related U.S. Application Data
(60) Provisional application No. 60/521,381, filed on Apr. 14, 2004.

(51) Int. Cl. A01B 79/00; A01B 59/043; A01B 63/118

(52) U.S. Cl. 172/1; 172/451; 172/260.5

(57) ABSTRACT

A harrow frame may be operable to permit pivoting of its ground working tool support arms between a first relative angle and a second relative angle. Pivoting may be achieved through a drive system and a lock controllable remotely such that the tool support arms can be pivoted about their fulcrums “on-the-fly” while the harrow frame is being moved along a ground surface. In addition or alternately, a harrow frame may also be folded to have a width less than 8.5 feet to facilitate transport.

### FIELD

The invention relates to harrow and in particular a harrow and a harrow frame therefore.

### BACKGROUND

Harrows are used in agricultural applications to work by loosening and aerating the soil. A harrow is towed through the field and includes a frame, generally conveyed on wheels, and ground working tools mounted on the frame.

It is desirable that the field be worked in as few passes as possible. Thus it is desirable that the harrow be as wide as structurally possible. However, this poses a problem in shipping the harrow and moving the harrow from field to field. In particular, many transport regulations require a permit in order to transport vehicle or load which is more than 10 feet (3.0 m) and often more than 8 ½ feet (2.6 m) wide. While many harrows can be folded, they often do not meet the non-permit width requirements.

A harrow is useful when it can be used for aggressively working the soil in a field to be planted as well as for lightly disturbing the soil to uproot weeds in a field that has already been planted. The degree to which the soil is worked by the harrow is determined by the angle, termed angle of aggression, at which the 20 harrow is passed over the field. It is desirable that the harrow has a variable angle of aggression for versatility. While some harrows are available with variable aggression angles, the adjustment of the angle of aggression is complex and requires stopping the harrow and making several manual adjustments. In particular, with reference to FIG. 1, a prior art harrow is shown which includes a frame having a left tool support arm 2a and a right tool support arm 2b that each support a harrow ground working tool 3, such as a rotary spike harrow. The arms 2a, 2b extend outwardly from a drive carriage 4 that rides along a center beam 1 of the frame. During use, the arms are held out at a selected angle from drive carriage 4 by locking the drive carriage at a selected position along the center beam and by adjustment of stabilizer beams 6 and tension chains 7. The stabilizer beams support arms 2a, 2b from behind and the tension chains prevent the arms from folding away from the hitch until the chains are released. Arms 2a, 2b can be repositioned to have a selected angle of aggression or folded back away from the hitch by manually unlocking the drive carriage from the center beam and moving it along the center beam by adjusting the angle between the stabilizer beams by use of hydraulic cylinders 9 and by adjusting each tension chain 7 length by manually releasing and reconnecting the chains or by working a winch. As will be appreciated, arm repositioning requires much manual adjustment and coordination between hydraulic cylinders 9 themselves and between the cylinders and the chains.

When attempting to fold the harrow, the tension in chains 7 is released and stabilizer beams 6 are driven together above center beam 1, which drives carriage 4 forwardly along the center beam. This pulls supports arms 2a and 2b back toward tail harrow 8. The folding is hindered by the presence the tail harrow 8, the wheels supporting the center beam and the ground working tools. This prevents the harrow from being folded to anything less than about 13 feet (4 m).

### SUMMARY

A harrow frame has been invented that facilitates selection and adjustment of an angle of aggression. The harrow angle of aggression may be adjusted “on-the-fly”, while the harrow is being moved along the ground, for example during ground treatment therewith or while the harrow is being moved to, from or between fields. In another embodiment, the frame may be folded for transport. The frame may also include one or more other features that facilitate use of the harrow.

In accordance with a broad aspect of the present invention, there is provided a harrow frame for supporting a harrow ground working tool, the harrow frame comprising: a towing end, a center unit, a right tool support arm being elongate and having a secured end and an outboard end, a left tool support arm being elongate and having a secured end and an outboard end, the left tool support arm and the right tool support arm each acting as levers each with a fulcrum on their secured ends through which they engage the center unit, a drive system acting adjacent the secured ends of the tool support arms to pivot the left tool support arm and the right tool support arm about their fulcrums to move them between a first relative angle and a second relative angle and a lock to releasably lock the left tool support arm and the right tool support arm into the first relative angle and the second relative angle, the drive and the lock being controllable remotely such that the left tool support arm and the right tool support arm can be pivoted about their fulcrums while the harrow frame is being moved along a ground surface.

The harrow frame tool support arms may be locked and driven substantially exclusively through connections adjacent their secured ends. In one embodiment, those connections may be provided between their secured ends and their fulcrums. In one embodiment, the lock and/or the drive system may be selected to act without relying on the use of support beams or tension chains connected to the tool support arms between the fulcrum and the outboard end.

In one embodiment, the first relative angle may be a first selected angle of aggression and the second relative angle may be a second selected angle of aggression. In another embodiment, the first relative angle may be an open position for use and the second relative angle may be a folded position. In the folded position, the relative angle between the left tool support arm and the right tool support arm may be such that the width defined between the outer limits of the left tool support arm and the outer limits of the right tool support arm may be less than 8.5 feet.

The drive system may include, for example, a magnetic drive rod system, a screw drive, a chain drive, an air cylinder, a hydraulic cylinder, etc. The drive system may be connected to the left tool support arm and the right tool support arm such that any drive generated by the drive system may be conveyed to the tool support arms substantially simultaneously. For example, a drive shaft of the drive system may be connected to both the left tool support arm and the right tool support arm such that any drive is conveyed substantially identically to both arms. In one embodiment, the lock may be incorporated into the drive system, as for example by use of a locking cylinder.

In accordance with another broad aspect of the present invention, there is provided a harrow frame for supporting a harrow ground working tool, the harrow frame comprising: a towing end, a center unit, a right tool support arm being elongate and having a secured end and an outboard end; a left tool support arm being elongate and having a secured end and an outboard end, the left tool support and the right tool support arm each acting as levers each with a fulcrum on their secured ends through which they engage the center unit, a drive system acting adjacent the secured ends of the tool support arms to pivot the left tool support arm and the right tool support arm substantially simultaneously about their fulcrums to move them between a folded condition and an open position for use and a lock to releasably lock the left tool support arm and the right tool support arm into the open position for use, the drive system, the lock and the fulcrums selected such that in the folded condition, the frame has a width of less than 8.5 feet.

The drive system may include, for example, a magnetic drive rod system, a screw drive, a chain drive, an air cylinder, a hydraulic cylinder, etc. The drive system may be connected to the left tool support arm and the right tool support arm such that any drive generated by the drive system may be conveyed to the tool support arms substantially simultaneously. For example, a drive shaft of the drive system may be connected to both the left tool support arm and the right tool support arm such that any drive is conveyed substantially identically to both arms.

To reduce the folded size of the frame, the drive system can be positioned such that it may be substantially outside of the area between the folded tool support arms. In one embodiment, the drive system may be positioned between the towing end and the center unit and the tool support arms fold away from the towing end behind the center unit.

In one embodiment, the lock acts adjacent the secured ends to lock the left tool support arm and the right tool support arm into the open position for use. In one embodiment, the lock may be incorporated into the drive system, as for example by use of a locking cylinder.

Wheels or other transport supports can be provided in any configuration to support the frame such that it can be pulled over a field to be worked or pulled for transport when not in use. In one embodiment, there may be at least one wheel positioned to support the center unit and at least one wheel to support the outboard end of each tool support arm. To facilitate operation, a wheel supporting the center unit may be fixed substantially against pivoting about a vertical axis while wheels supporting the tool support arms are capable of pivoting about a substantially vertical axis (i.e. caster-style wheels).

In one embodiment, the harrow frame may include a trailing unit for supporting a tail harrow ground working portion, the trailing unit having an outboard end and a secured end. In one embodiment, the harrow frame includes a lift mechanism to raise the outboard end of the trailing unit upwardly during a folding operation to permit the left tool support arm and the right tool support arm to be folded together and positioned under the trailing unit. The harrow frame can include a safety lock selected to prevent the left and right tool support arms from being moved into the folded configuration without the trailing unit first being raised upwardly. In another embodiment, there may be provided a safety lock to prevent the support arms from unfolding inadvertently. For example, the trailing unit can include a safety lock, which may be selected to lock the right tool support arm and the left tool support arm together in the folded configuration by setting the trailing unit down on the tool support arms when they are folded together therebelow.

In accordance with another broad aspect of the present invention, there may be provided a harrow frame for supporting a harrow ground working tool, the harrow frame comprising: a hitch, a center unit, a right elongate tool support arm having a secured end and an outboard end, a left elongate tool support ann having a secured end and an outboard end, the left tool support and the right tool support arm each including a first bracket and a second bracket spaced apart on the tool support arm for engaging the ends of a ground working tool to be mounted on the frame, the first bracket including an end connected to the tool support arm, a connector end for engaging the ground working tool and a pivotal connection between the tool support arm and the connector end selected to permit the connector end to pivot relative to the end secured to the tool support arm and independently of the second bracket.

In accordance with another broad aspect there is provided a method for operating a harrow comprising: providing a harrow including a center unit, a right tool support arm including a ground working tool secured thereto, a left tool support arm including a ground working tool secured thereto, and a drive system operable to pivot the right tool support arm and the left tool support arm relative to the center unit, operating the drive system to pivot the right tool support arm and the left tool support arm into a first operational position at a first angle of aggression; working a field with the harrow in the first operational position; remotely operating the drive system to pivot and lock the right tool support arm and the left tool support arm into a second operational position at a second angle of aggression different from the first angle of aggression; and working a field with the harrow in the second operational position.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a perspective view of a prior art harrow.

FIG. 2 is a top plan view of a harrow frame.

FIGS. 3A, 3B and 3C are top plan views of a harrow in a position with a 25° angle of aggression, in a position with a 45° angle of aggression and in a folded configuration, respectively.

FIGS. 4A, 4B and 4C are enlarged top plan views of the drive system in the 25° angle of aggression configuration, the 45° angle of aggression configuration and the folded configuration, respectively.

FIG. 5A is a top plan view of a drive system useful in the present invention.

FIG. 5B is a side view of a center unit and trailing unit useful in the present invention.

FIG. 6 is a front elevation of a tail harrow bracket useful in the present invention.

FIG. 7 is an enlarged view of a ground working tool bracket useful in the present invention.

FIG. 8A is a top plan view of another harrow frame according to the present invention.

FIGS. 8B to 8F are enlarged top plan views of various configurations of a drive system useful in the harrow frame of FIG. 8A. FIG. 8B shows a top plan view and FIG. 8C shows a front elevation of the drive system in a configuration which would hold the ground working tools at about a 45° angle of aggression. FIGS. 8D, 8E and 8F are side, front and top views, respectively, of the drive system in a configuration which would hold the ground working tools at about a 25° angle of aggression.

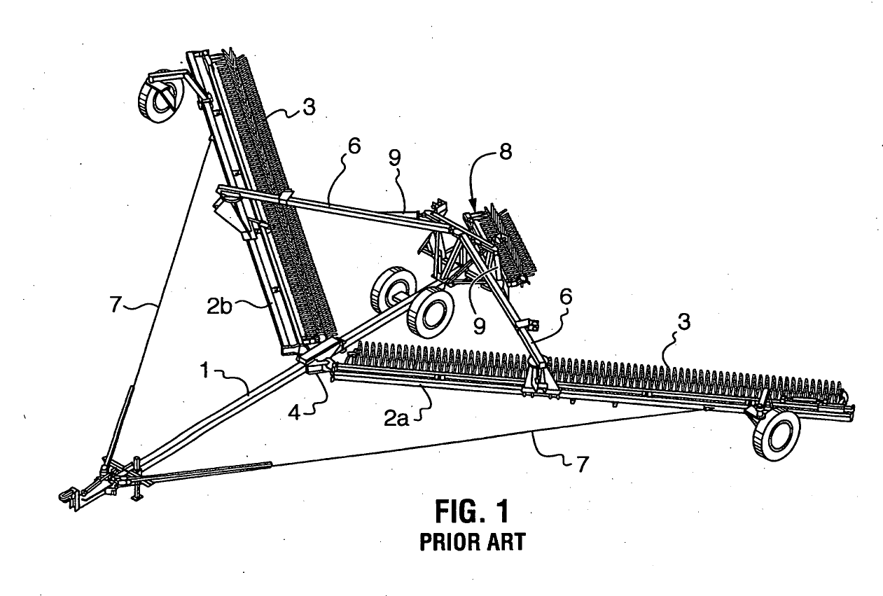

### DETAILED DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

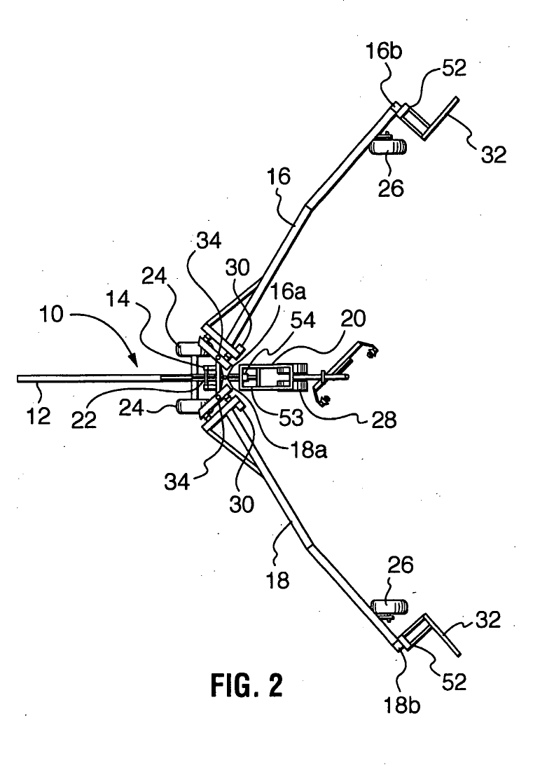

Referring to FIG. 2 there is shown one embodiment of a harrow frame 10 that may include a hitch 12, a center unit 14, a right tool support arm 16, a left tool support arm 18, a trailing unit 20, a drive system 22 for driving the tool support arms into various relative angles and a plurality of wheels 24, 26, 28 for supporting the frame during transport.

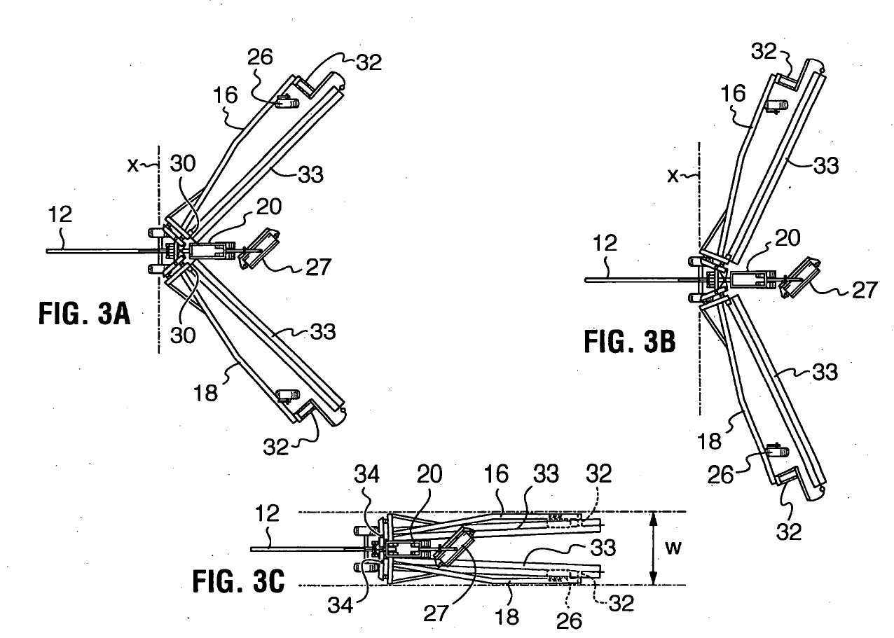

The harrow frame, when in use, may have mounted thereon ground working tools 27, 33, as shown in FIG. 3, and may be pulled about a field to work the soil therein. Thus, the frame may be suitable for towing by a vehicle such as a truck or tractor by connection through hitch 12 or by other means. The frame may be formed to withstand the stresses to be placed thereon by use. In the illustrated embodiment, for example and as will be appreciated, the frame may be formed of rigid, durable beams such as 2 to 6 inch square steel tubes interconnected, as by welding or bolting, using a truss form, where necessary, for strength. The frame may be supported on wheels 24, 26, 28 for transport through the field or on roadways. Wheels 24 are positioned to support mainly the center of the frame, while wheels 26 and 28 support mainly the ends of the tool support arms and the trailing unit, respectively. Wheels 24 and 28 can be fixed to rotate in planes parallel to the long axis of the frame. Wheels 26 may be caster style wheels to support movement of the arms, as will be appreciated. Placing wheels 24 under the heavy center unit and without the ability to pivot about a vertical axis may act against side drift problems during use of the harrow. It is to be understood that some of the wheels can be removed and/or moved about as desired, for example, to correspond with the means of towing. For example, the hitch can be shortened or the frame can be connected closely to the towing vehicle such that wheels 24 may no longer be needed.

Each of the right tool support arm 16 and the left tool support arm 18 may be elongate and have an end 16a, 18a secured to the center unit and an opposite, outboard end 16b, 18b. The tool support arms may each include brackets 30, 32 for each engaging its harrow ground working tool 33 (FIGS. 3A and 3B) at its ends. The tool support arms are extended out from the center unit as shown in FIG. 2 with a relative angle therebetween (i.e. the angle between the long axis of each of the tool arm and the center unit). The relative angles can include those associated with an in-use configuration or a folded configuration. With respect to an in-use configuration, the tool support arms 16, 18 can be extended outwardly at various angles to select the degree to which the ground working tools engage the ground. This is termed “angle of aggression”. The angle of aggression is commonly referenced as that angle between the ground working tools (i.e. as determined by the position of tool support arms) and a horizontal axis, x, orthogonal to the long axis of the harrow frame through the hitch (see FIG. 3). Generally, the most useful angles of aggression range between 25° and 45°. For example, generally the harrow may be used with the tool support arms in a 45°0 angle of aggression as shown in FIG. 3A, in a 25° angle of aggression as shown in FIG. 3B or at any selected angle between 25° and 45°.

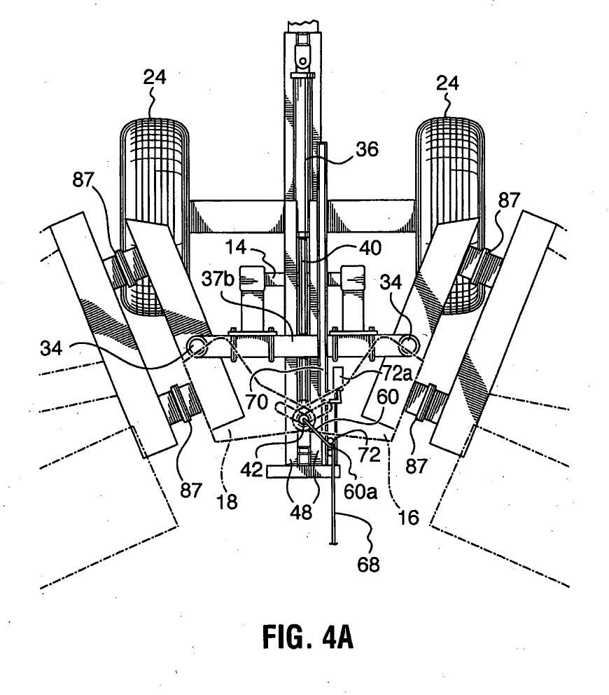

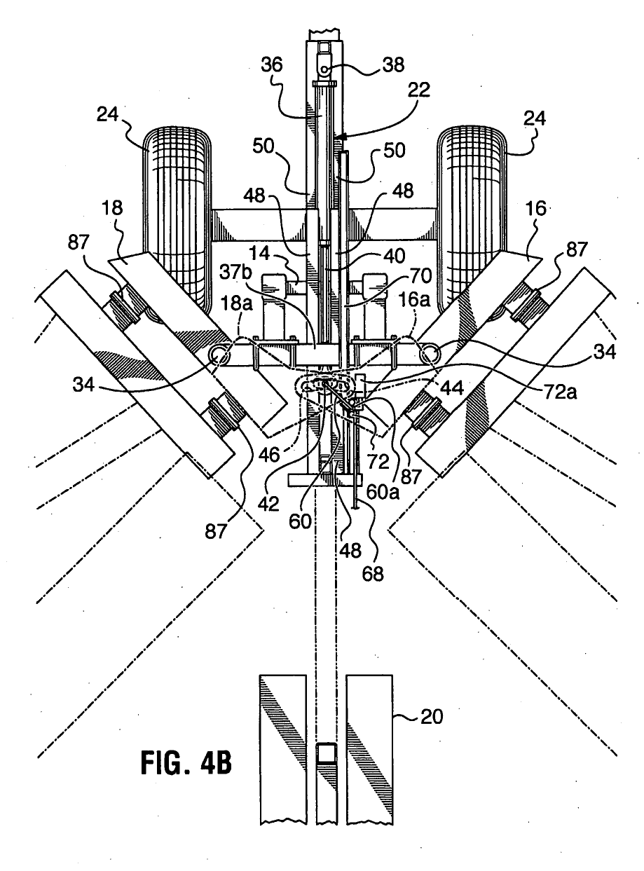

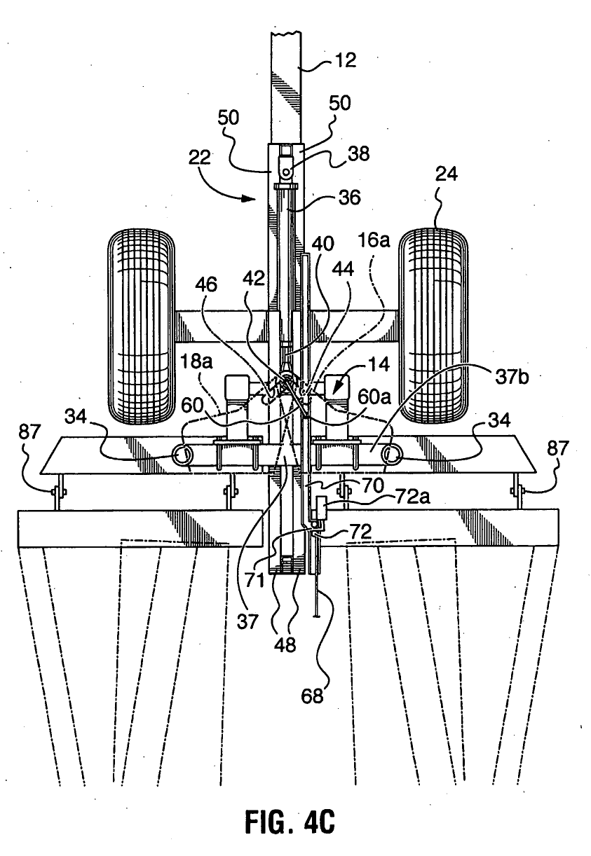

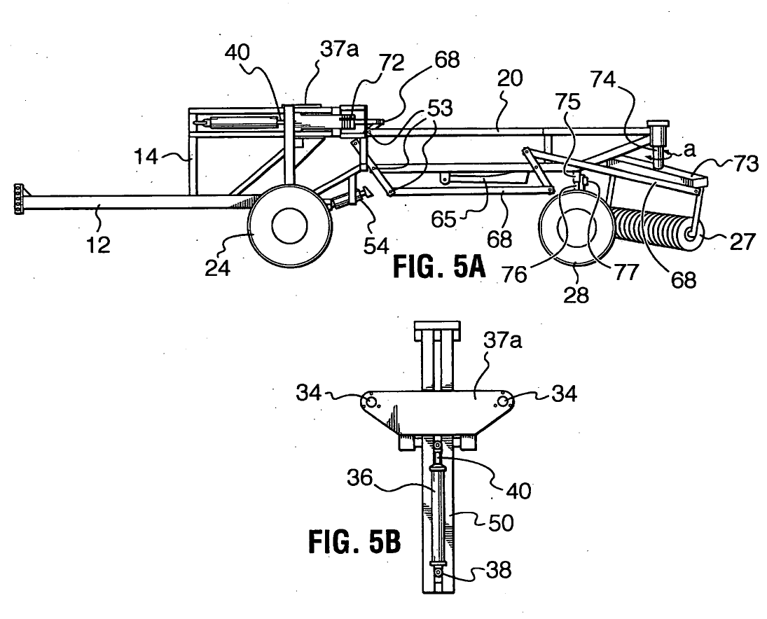

In the in-use condition, the harrow can be quite wide such as for example 40 or 50 feet (12 or 15 m) from end 16b to end 18b. In one embodiment, the harrow can be further widened, for example, by insertion of additional beam lengths, as by use of a flanged bolt plate, into the tool support arms. Thus, it is desirable that the tool support arms be foldable (FIG. 3C) to reduce the width of the tool for transport and storage. Therefore, while the tool support arms can be locked into the in-use condition, the tool support arms can each act as levers about the center unit. In particular, each tool support arm may include a fulcrum 34 adjacent its secured end where it is fixed on the center unit and permitted to pivot in a plane substantially parallel to the ground surface on which the frame is placed (i.e. generally horizontally). The fulcrum can be formed in any way such as by insertion of a pin through an opening on the support arm. The pin may be secured in various ways on the center unit such as, for example, between rigid members such as plates 37a (FIG. 5) or bars 37b (FIG. 4) of the center unit. For simplicity and strength, the fulcrums can be fixed on the center unit and mount the tool arms onto the center unit directly, rather than using an intermediate moveable carriage or link.

Drive system 22 may act adjacent the secured ends of the tool support arms to pivot the left tool support arm and the right tool support arm about their fulcrums to move them between a folded condition and an open in-use position. In one embodiment, the drive system may be selected to be capable of driving the movement of the tool support arms while the harrow frame is being moved, during use or during transport before or after use. In such an embodiment, any components of the drive system, the tool support arms and any connections therebetween may be selected to withstand the stresses of such simultaneous arm pivoting and harrow movement. The drive system may be configured to permit the support arms to pivot in a substantially simultaneous way. The drive system may be connected to each of the tool support arms between their fulcrums 34 and their secured ends 16a, 18a. Drive system 22, in the illustrated embodiment, includes a hydraulic cylinder 36 mounted at a fixed end 38 to the center unit and with a rod 40 pivotally connected by a pin 42 into slots 44, 46 in the tool support arms 16, 18, respectively. Using one cylinder, the arms can be pivoted at the same rate without the need to synchronize with other drive system components. The tool support arms may be formed at their secured ends to permit overlap such that they can each be in engagement with the pin, but each able to pivot freely without interference therebetween. In particular, secured ends 16a, 18a of the tool support arms may be formed as plates or c-shaped members to permit alignment of slots 44, 46 so that pin 42 can be passed therethrough. Extension or retraction of rod 40 can drive, by engagement of pin 42 in slots 44, 46, the tool support arms about their fulcrums to pivot in the horizontal plane. In this particular embodiment, pin 42 may be restrained to move along an upper and a lower aligned guide rails 48, 50 to urge the pin and rod to move along a selected axis and to seek to prevent the pin from adversely twisting, for example, out of a substantially vertical plane. The limits of extension and folding of the tool support arms can be established by selecting the stroke length of the rod, with respect to the position of the fulcrums or by placement of stops against which the tool support arms or rod can abut. In one embodiment, hydraulic cylinder 36, pin 42, tool support arms 16, 18 and the various connections of these components are selected to permit movement of the tool support arms while the harrow frame is being moved.

As will be appreciated, the drive system can include drive sources other than a hydraulic cylinder, such as, for example, an air cylinder, a screwdrive, a chain drive, a magnetically driven shaft, without substantially changing its operation.

A lock may be required to releasably lock the tool support arms into a selected relative angle. Where the drive system is based on a hydraulic cylinder, as shown, the lock may be embodied by a locking valve for hydraulic cylinder 36 that permits the rod to be locked once in a selected position. The locking valve is selected to withstand the pressures, such as for example 500 to 1,500 psi, necessary to hold the tool support arms in an extended position while the harrow is being used. Thus, if desired, no support beams or tensioning chains need be connected between the hitch, center unit or trailing unit and the tool support arms to maintain the arms in an extended in-use position.

As noted previously, the tool support arms may each include brackets 30, 32 for engaging harrow ground working tool 33 (FIGS. 3A and 3B) at its ends. The brackets may be formed to cantilever the ground working tool behind the support arm on which it is mounted. This leaves room for wheels 26 to be positioned more directly under the support arms, if desired, thereby reducing twisting stresses on the arm. To facilitate transport of the harrow as shown in FIG. 7, brackets 32 may be pivotally connected, for example as shown at 51, to their support arms and a hydraulic lift 52 may be provided between each support arm and bracket so that the bracket can be lifted to thereby lift the connected ground working tool upwardly out of contact with the ground. A hydraulic lift (not shown) may also be provided on brackets 30. However, sufficient ground clearance can sometimes be achieved by lifting only one end of the ground working tool. Thus, one or the other of hydraulic lifts can be omitted, as desired.

The harrow frame may often include a trailing unit 20. The trailing unit supports tail ground working tool 27, which is sometimes referred to as a tail harrow. The tail ground working tool, in use, may be operated to work the swath between ground working tools 33. It will be appreciated that while tool support arms 16, 18 can be folded back together to a certain degree, such folding may be limited by abutment therebetween of the trailing unit. Thus, in one embodiment, trailing unit 20 may be connected to center unit 14 by a pivotal connection 53 with a hydraulic lift 54 and by actuation of the lift, trailing unit 20 may be pivoted upwardly about connection 53. This raises the outboard end of the trailing unit out of the way so that support arms 16, 18 can be folded in below the trailing unit, as shown in FIG. 3C. In the illustrated embodiment, which includes (i) a lift for the trailing unit, (ii) fulcrums 34 selected to be less than 8 feet (2.5 m) apart, hydraulic lifts 52 for lifting ground working tools 33 and a drive system 22 between the hitch and the fulcrums, the harrow frame can be folded to a width, W, of less than 8.5 feet and, in one embodiment, less than 8 feet. This meets most transport regulations allowing transport on roadways without a permit.

In one embodiment, a safety lock system may be provided wherein the system prevents the support arms from being folded back toward trailing unit 20 beyond a selected angle unless the trailing unit has been lifted out of the way. This system can be embodied in various ways. In the illustrated embodiment for example, the system may sense the position of rod 40 of drive system 22. In particular, rod 40 may have attached thereto an extension 60, which rides along with the rod.

Extension 60 may have an end 60a that rides in a slot 70. When support arms 16, 18 are being folded out toward the hitch into an operative position, end 60a may ride in slot 70 toward trailing unit 20 and when the support arms are being folded in toward the tail harrow, extension end 60a may be retracted toward cylinder 36. At a selected position along the slot, which corresponds to the stroke length of rod 40 when support arms 16, 18 are moving outwardly and which may for example, correspond to a tool support arm position in an angle of aggression at about 45°, a diverting wall in slot 70 may be configured to force extension 60 into engagement with a slider 72 disposed in the slot. Referring to FIG. 4B, slider 72 may be slidably mounted in an end of slot 70 and may include an opening 71 sized to engage extension end 60a. Opening 71 may pass through the slider. Extension 60 may drop into the opening from an inner side, while a control bar 72a may extend into the opening in slider 72 from the opposite side. When extension 60 is forced into the opening, it may push the control bar out of the opening. When control bar is pushed out, this may cause the hydraulic system to be locked such that support arms 16, 18 cannot be folded back beyond 45°0 until the system is unlocked. The system can be unlocked by raising trailing unit 20. When the trailing unit is raised, the rod 40 can be retracted such that arms can fold back past about 45°. In so doing, slot 70 diverts extension end 60a to pull out of slider 72 and the control bar can drop back into the opening in slider to reset the locking system. In addition, the control bar may maintain the slider in position along slot 70 so that extension 60 can drop into the opening, when rod 40 drives it out. Extension 60 may also be useful in other harrow control systems, as will be described in more detail hereinbelow. However, of course, extension 60 and the related components need not be used if other means are desired or if no folding prevention lock is desired.

The above-noted safety lock system may also be useful for controlling the operation of hydraulic lift 52 and the hydraulic lift on bracket 30. In particular, the safety lock system can prevent the ground working tools 33 from being lifted while the support arms are between 25° and 45°. In addition, the safety lock system may prevent the arms from being folded toward tail harrow 27 until the ground working portions 33 are lifted.

Another safety mechanism can be provided wherein the trailing unit may include a clamp 65 that can be secured over the arms when they are folded beneath the trailing unit. Such a clamp may assist in holding the frame in a folded configuration and acts against inadvertent unfolding, for example, during transport.

While it is useful to be able to move the tool support arms between a folded configuration and an in-use position, it is also desirable to adjust the position of the arms when in the in-use position, for example, to adjust their angle of aggression. It is useful to have the functionality to both unfold the arms and set their angle of aggression “on-the-fly” when the harrow is moving, in use or during towing. As an example, when the harrow is moving, usual speeds are at least about 3 miles/hour (5 km/hr), with a common speed being between about 3 to 15 miles/hour (5 to 24 km/hr) and it is useful if the angle of aggression of the support arms may be adjusted at these speeds. In some more common applications, it is desirable that the angle of aggression be adjustable at speeds of between about 6 to 10 miles/hour (10 to 16 km/hr).

As noted hereinbefore, the angle of aggression is commonly referenced as that angle between the ground working tools and horizontal axis, x, orthogonal to the long axis of the harrow frame through the hitch. Generally, the most useful angles of aggression range between 25° and 45°. For example, generally the harrow may be used with the tool support arms in a 45° angle of aggression as shown in FIG. 3A, in a 25° angle of aggression as shown in FIG. 3B or at any selected angle between 25° and 45°. The greater the angle of aggression, the greater the tilling action achievable by the ground working tool.

The angle of aggression of the present harrow frame can be set by the drive system alone, for example using a drive system as previously described and wherein, for example, various angles of aggression are achieved at various positions along the stroke length of rod 40. For example, the drive rod can be stopped and locked at a minimum stroke length for a folded configuration, an intermediate stoke length for an angle of aggression at about 45° and a maximum stroke length for an angle of aggression at about 20°. Using the drive system to set the angle of aggression provides that the angle of aggression can be adjusted remotely and the arms can be releasably locked into a selected angle of aggression, for example, from the safety of the operator's compartment of a towing vehicle without a need to manually adjust or lock anything on the frame. Thus, the angle of aggression can be adjusted and locked while the harrow is being moved or used, for example while towing at at least 3 miles/hour. The drive system, again for example as defined above, may be selected to move the support arms substantially simultaneously at about the same rate and, therefore, may be used while the harrow is in motion without destabilizing it by unbalancing the forces between the support arms.

A control system may be provided for control of drive system 22 and other components on the harrow frame, such as hydraulic cylinders extraneous to the drive system. The control system can include, for example, a control panel conveniently positioned remote from the harrow frame, for example in the driver compartment of the vehicle, and connections, including any of wired, wireless or mechanical connections, to the drive system. In one embodiment, the control system can the include control panel selections to move the frame into various selected positions such selections may include, for example, “folded”, “45°” and “25°”. To simplify the harrow, there can be a central hydraulic fluid tank, lines leading from the tank to the various cylinders and valves in the lines actuable through the control system.

The harrow can therefore be operated to pivot the right tool support arm and the left tool support arm into a first operational position at a first angle of aggression wherein the harrow can be used to work a field with the harrow in the first operational position. Then, the harrow can be remotely operated, as from the control panel in the driver compartment to cause the drive system to pivot and lock the right tool support arm and the left tool support arm into a second operational position at a second angle of aggression different from the first angle of aggression. Thereafter, the field can be worked with the harrow in the second operational position. The process of working, in some cases, may not even need to be interrupted as the tool support arms can be worked while the harrow is moving and possibly even while the field continues to be worked.

In one embodiment, the angle of aggression of tail harrow 27 can also be adjusted. In the illustrated embodiment, the angle of aggression of the tail ground working tool 27 can be adjusted between 25° and 45°, which may correspond to the angle of the ground working tools 33 on the support arms. In one embodiment, for example, a communicator may be provided to communicate the position of tool support arms 16, 18 to the support system of the tail ground working portion. For example, slider 72, which was described hereinabove, may be connected to drivingly engage a linkage 68 that selects the angle of aggression of ground working tool 27 on the trailing unit. Linkage 68 may be pivotally connected at a plurality of positions to translate sliding movement of slider 72 to rotational movement of a shaft 74 journalled on the trailing unit. Rotational movement of shaft may cause a bracket 73 supporting ground working tool 27 to rotate, as indicated by arrow A.

Once extension 60 engages into slider 72, they may move together in response to movements of rod 40 until the extension is retracted by the rod to disengage from the slider. Linkage 68 may be selected such that when arms 16, 18 are at any particular angle of aggression, bracket 73 may be at a substantially similar angle of aggression.

When using a harrow on an uneven ground surface it is sometimes difficult to evenly work the soil. In one embodiment of the present invention, various means may be provided to permit adjustment manually or automatically of the frame components and ground working tools relative to the ground. These various means can be used alone or in combination on any particular harrow.

In one embodiment, hydraulic lift 54 may be positioned to lift trailing unit 20 but when not in the lift position, may be selected to permit pivoting of the trailing unit relative to center unit 14 about pivotal connections 53. Thus, the trailing unit, when in use, can pivot relative to center unit 14 to maintain ground working tool 27 in contact with the ground even when passing over undulations in the ground surface. To permit free pivoting around connection 53, hydraulic lift 54 can, for example, be selected normally to be retracted completely and disconnected from the trailing unit, as shown. Alternately, hydraulic lift can be connected to the trailing unit but may include an open hydraulic circuit that unlocks the hydraulic fluid flow when the lift is not acting to lift the trailing unit.

In addition or alternately, the position of wheel 28 can be adjusted to select the height at which trailing unit 20 is conveyed and, thereby, the depth to which ground working tool works the soil. In particular, wheel 28 may be mounted using an extendable support. An extendable support may include a shaft 75, which may be telescopically disposed within a tube 76. The degree to which shaft 75 extends into tube 76 may determined by a turnbuckle 77.

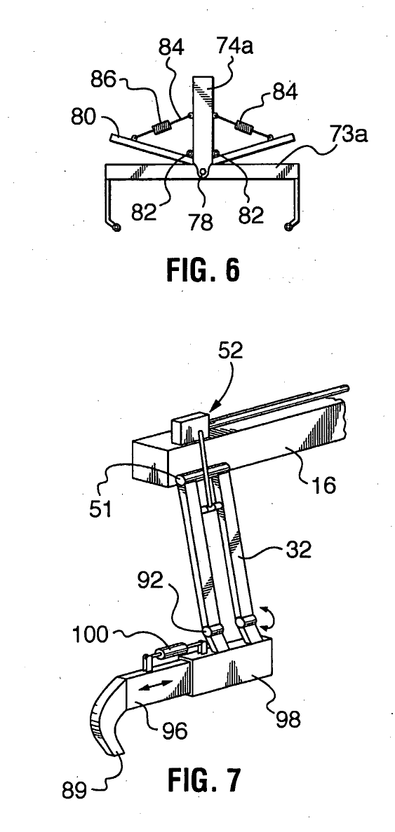

In another embodiment shown in FIG. 6, the bracket 73a of the tail harrow may be formed to pivot or be at least in part adjustably fixed in a selected angle off horizontal. In particular, bracket 73a may include eyes for connection of a ground working tool and a pivotal connection 78 may be provided between bracket 73a and shaft 74a such that frame can pivot in a substantially vertical plane about the. shaft. If it is desired to adjust the degree to which the frame can pivot, adjustable stops 80 can be mounted on shaft above bracket 73a. Stops 80 may be pivotally connected at 82 to shaft and rods 84 may be mounted to maintain the stops in a selected orientation relative to shaft, as determined by the lengths of rods 84. The lengths can be selected in various ways as by use of turnbuckles 86. Thus, in use, bracket 73a can pivot vertically about connection 78 as limited by abutment against stops 80.

In another embodiment, the tool support arms may include hinges 87 permitting the outboard end of the arms to pivot in a substantially vertical plane. This may permit the outboard ends of arms 16, 18 to pivot to adapt to undulations in the ground surface. Hinges 87, however, may not adversely affect the folding or angular orientation of the arms since they act about another axis.

In another embodiment, brackets 30, 32 may be selected to permit the ends of each ground working tool 33 on arms 16 and 18 to flex independently. In particular, brackets 30, 32 may each have pivotal connections therein which may be formed to respond to the weight of the ground working tool to keep it in engagement with the ground. A bracket 32a useful in this embodiment is shown in FIG. 7. Bracket 32a may be mounted to arm 16 at one end and at its other end may include a connector 89 for securing a ground working tool (not shown). Bracket 32a may include a pivotal connection 51 about which hydraulic drive 52 may operate to lift the bracket, as was described hereinbefore. Bracket 32a can pivot about connection 51 when driven by the hydraulic drive and otherwise may be locked against pivoting at this connection. To provide for flex in the arm in response to undulations in the ground surface, another pivotal connection 92 may be provided between connection 51 and connector 89. Bracket 32a can flex in response to forces acting on the bracket below pivotal connection 92. Pivotal connection 92 may be selected to maintain tension in tool 33 by maintaining spacing between brackets 30, 32. If desired, bracket 30 can also be formed to have a pivotal connection therein.

FIG. 7 illustrates another possible embodiment, wherein connector 89 may be positioned on a shaft 96 that is telescopically disposed in a tube 98. The extension of shaft 96 from tube 98 can be selected by use of a turnbuckle 100. This permits the ground working tool 33 to be placed under whatever tension is desirable for its functioning, but without extending shaft 96 laterally outwardly from the harrow frame anymore than is desirable to tension the ground working tool.

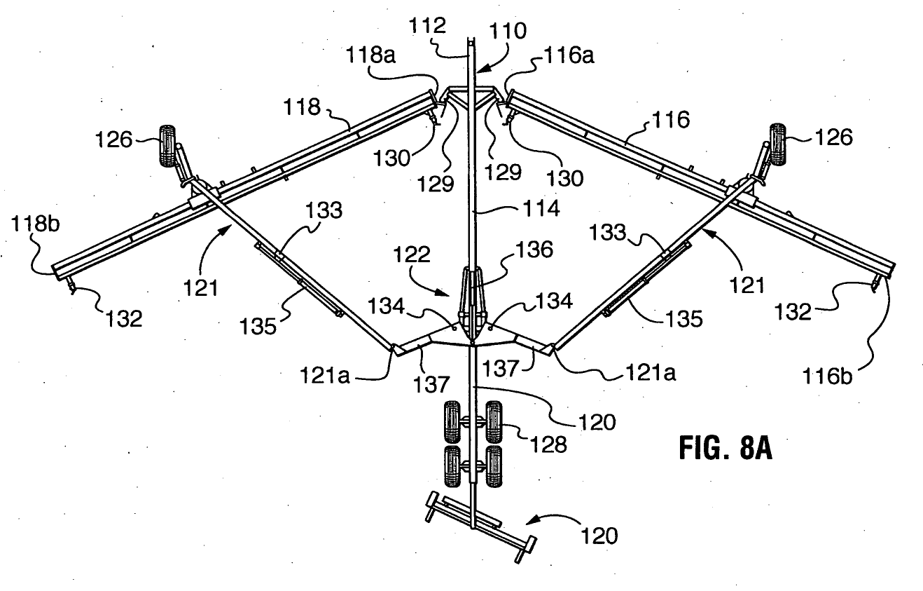

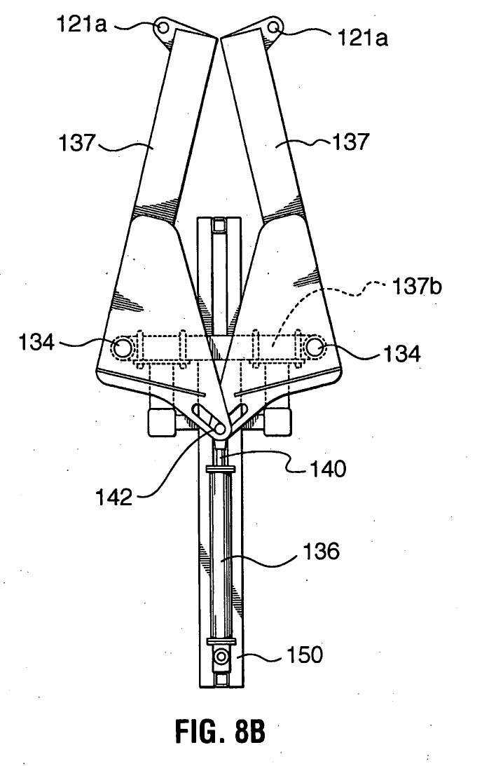

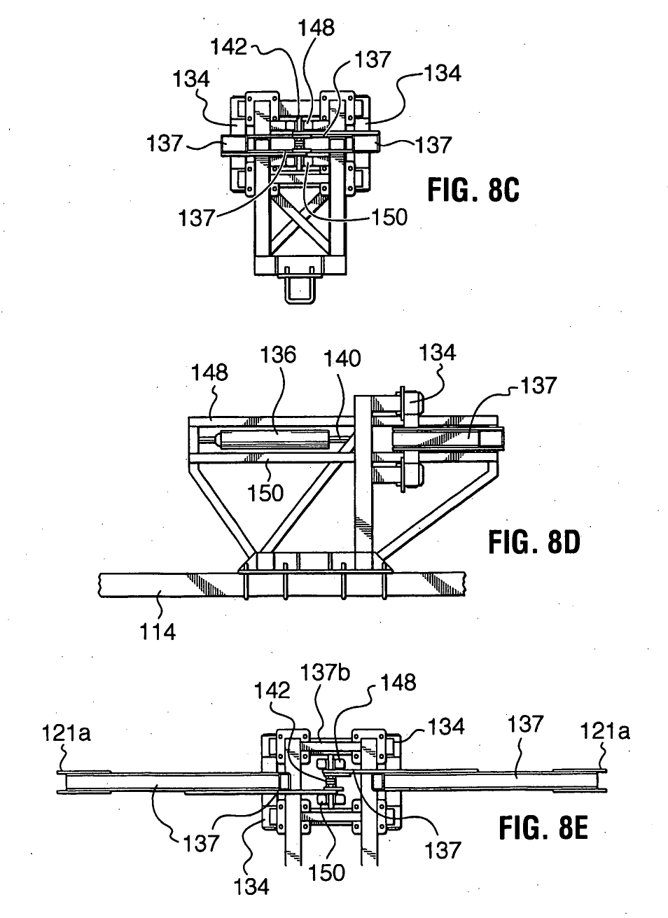

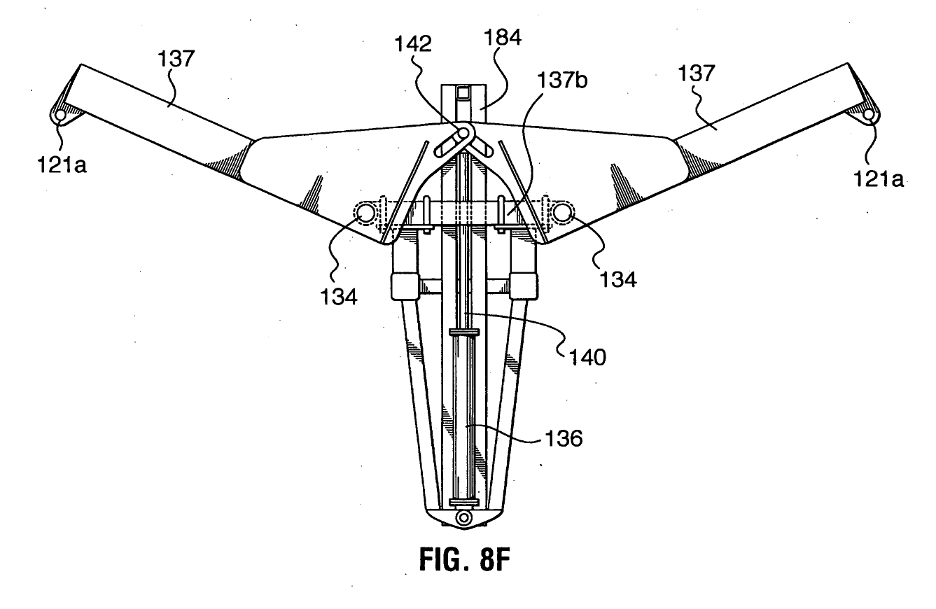

Referring to FIG. 8A, there is shown another harrow frame 110 which may include a hitch 112, a center beam 114, a right tool support arm 116, a left tool support arm 118, a trailing unit 120, two expansion beams 121 for driving the tool support arms between a folded position and an open in-use position, a drive system 122 for driving the tool support arms between selected angles of aggression once the arms have been expanded by the expansion beams into the in-use position and a plurality of wheels 126, 128 for supporting the frame during transport.

Each of the right tool support arm 116 and the left tool support arm 118 may be elongate and may have an end 116a, 118a pivotally secured through pivots 129 to the center beam. Arms 116, 118 may also have outboard ends 116b, 118b, respectively. The tool support arms may each include brackets 130, 132 for engaging the ends of a harrow ground working tool (not shown). When in use, the tool support arms may be extended out from the center unit as shown. However, the frame can be folded by use of folding beams 121 to drive arms 116, 118 around pivots 129 toward center beam 112. In particular, the folding beams may each be pivotally connected to their support arms and may each include a hinge 133 about which the beam can fold. The folding of beams 121 may be driven by cylinders 135. When the cylinders are retracted, the beams can fold to draw arms 116, 118 inwardly toward the center beam. When cylinders 135 are extended, the beams may be locked in an extended position to support the support arms in the working position.

When the tool support arms 116, 118 are extended out by the folding beams, the drive system 122 can be used to adjust the angle of aggression of the arms to select the degree to which the ground working tools engage the ground. In one embodiment, the beams may be selected to drive the arms from a folded condition to a 45° angle and the drive system may selected to drive the arms between 45° and 25°. Referring also to FIG. 8B, folding beams 121 may each be connected at hinge 121a to a drive lever 137. Drive system 122 may drive the beams through levers 137 that pivot about fulcrums 134 to adjust the angle of aggression of arms 116, 118. The fulcrums 134 may be secured on rigid beams 137a of the drive system frame.

Drive system 122, in the illustrated embodiment, may include a hydraulic cylinder 136 mounted to the drive system frame with a rod 140 pivotally connected by a pin 142 to levers 137. Using one cylinder, the levers and thereby the beams can be pivoted at the same rate without the need to synchronize. Extension or retraction of rod 140 may drive pin 142 to pivot levers 137 about their fulcrums in a horizontal plane. Pin 142 may be restrained to move in an upper and a lower aligned guide rails 148, 150 to urge the pin and rod move along a selected axis and to seek to prevent the pin from twisting substantially out of a vertical plane. The limits of extension of the tool support arms can be established by selecting the stroke length of the rod, with respect to the position of the fulcrums and the lengths of the expansion beams or by placement of stops against which the tool support arms or rod can abut.

In one embodiment, to reduce the folded width of the harrow as much as possible brackets 130, 132 may each be provided with hydraulic lifts to raise the height of the attached ground working portion above wheels 128 and trailing unit 120 can be pivoted orthogonally to center beam 114 to permit support arms 116, 118 to fold in above center beam and between the trailing unit and the hitch.

As will be appreciated, the drive system can include drive sources other than a hydraulic cylinder such as, for example, a screw drive without changing its operation. The drive system may include a locking valve for hydraulic cylinder 136 that permits the rod to be locked once in a selected position. The locking valve may be selected to withstand the pressures, such as for example 1,500 psi, necessary to hold the tool support arms in an extended position while the harrow is being used.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are know or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A harrow frame for supporting a harrow ground working tool, the harrow frame comprising: a hitch, a center unit, a right tool support arm being elongate and having a secured end and an outboard end, a left tool support arm being elongate and having a secured end and an outboard end, the left tool support arm and the right tool support arm each acting as levers each with a fulcrum adjacent their secured ends through which they engage the center unit, a drive system acting adjacent the secured ends of the tool support arms to pivot the left tool support arm and the right tool support arm about their fulcrums to move them between a first relative angle and a second relative angle and a lock to releasably lock the left tool support arm and the right tool support arm into the first relative angle and the second relative angle, the drive and the lock being controllable remotely such that the left tool support arm and the right tool support arm can be pivoted about their fulcrums while the harrow frame is being moved along a ground surface.

2. The harrow frame of claim 1 wherein the left and right tool support arms are locked and driven substantially exclusively through connections adjacent their secured ends.

3. The harrow frame of claim 2 wherein the connections are provided between the tool support arm secured ends and the tool support arm fulcrums.

4. The harrow frame of claim 1 wherein the lock is selected to act without relying on the use of tension chains connected to the tool support arms between the fulcrum and the outboard end.

5. The harrow frame of claim 1 wherein the drive system is selected to act without manual adjustment of any components on the frame during operation of the drive system.

6. The harrow frame of claim 1 wherein the first relative angle is a first selected angle of aggression and the second relative angle is a second selected angle of aggression.

7. The harrow frame of claim 1 wherein the first relative angle is an open position for use and the second relative angle is a folded position.

8. The harrow frame of claim 7 wherein in the folded position, the relative angle between the left tool support arm and the right tool support arm is such that the width defined between the outer limits of the left tool support arm and the right tool support arm is less than 8.5 feet.

9. The harrow frame of claim 7 wherein the drive system is positioned such that it is substantially outside of an area in which the tool support arms are positioned in the folded position.

10. The harrow frame of claim 1 wherein the drive system is positioned between the towing end and the center unit and the tool support arms fold away from the towing end behind the center unit.

11. The harrow frame of claim 1 wherein the drive system includes a hydraulic cylinder connected the left tool support arm and the right tool support arm such that any input drive of the drive system is conveyed substantially simultaneously to the tool support arms.

12. The harrow frame of claim 1 wherein the lock is incorporated into the drive system by use of a locking hydraulic cylinder.

13. The harrow frame of claim 1 wherein the fulcrums are mounted in a fixed position on the center unit.

14. The harrow frame of claim 1 wherein the lock acts adjacent the secured end to lock the left tool support arm and the right tool support arm into the open position for use.

15. The harrow frame of claim 1 further comprising a wheel positioned to support the center unit, the wheel fixed substantially against pivoting about a vertical axis.

16. The harrow frame of claim 1 further comprising a trailing unit for supporting a tail harrow ground working portion, the trailing unit having an outboard end and a secured end.

17. The harrow frame of claim 16 further comprising a lift mechanism to raise the outboard end of the trailing unit upwardly to permit the left tool support arm and the right tool support arm to be folded under the trailing unit.

18. The harrow frame of claim 7 further comprising a trailing unit for supporting a tail harrow ground working portion, the trailing unit having an outboard end and a secured end and a lift mechanism to raise the outboard end of the trailing unit upwardly during a folding operation to permit the left tool support arm and the right tool support arm to be folded under the trailing unit.

19. The harrow frame of claim 18 further comprising a safety lock selected to prevent the left and right tool support arms from being moved into the folded configuration without the trailing unit first being raised upwardly.

20. The harrow frame of claim 18 further comprising a safety lock selected to lock the right tool support arm and the left tool support arm together in the folded configuration by setting the trailing unit down on the tool support arms when they are folded under the trailing unit.

21. A method for operating a harrow comprising: providing a harrow including a center unit, a right tool support arm including a ground working tool secured thereto, a left tool support arm including a ground working tool secured thereto, and a drive system operable to pivot the right tool support arm and the left tool support arm relative to the center unit, operating the drive system to pivot the right tool support arm and the left tool support arm into a first operational position at a first angle of aggression; working a field with the harrow in the first operational position; remotely operating the drive system to pivot and lock the right tool support arm and the left tool support arm into a second operational position at a second angle of aggression different from the first angle of aggression; and working a field with the harrow in the second operational position.

22. The method of claim 21 wherein the step of remotely operating is carried out while the harrow is moving.

23. The method of claim 21 wherein the step of remotely operating is carried out while the harrow continues to be operated to work a field.

24. The method of claim 21 wherein after working the field in the second operational position, the harrow is folded by the drive system.

25. The method of claim 21 wherein the drive system includes a locking hydraulic cylinder for pivoting and locking the right tool support arm and the left tool support arm into a second operational position.

26. The method of claim 21 wherein during the step of operating the drive system to pivot the right tool support arm and the left tool support arm into a first operational position a drive rod of the drive system engages an end of each of the right tool support arm and the left tool support arm and drives them each about fulcrums securing the right tool support arm and the left tool support arm to the center unit until the drive rod is stopped and locked at a stroke length intermediate a maximum and a minimum stroke length for the drive rod.

27. The method of claim 21 wherein the first angle of aggression and the second angle of aggression are each selected from angles of 25° to 45°, relative to an orthogonal axis to a long center axis of the harrow.
